(19) United States
(12) Patent Application Publication
(10) Pub. No.: US 2018/0357086 A1
(43) Pub. Date: Dec. 13, 2018

(54) CONTAINER VIRTUAL SWITCHING

(71) Applicant: Intel Corporation, Santa Clara, CA (US)

(72) Inventors: Ray Kinsella, Limerick (IE); Namakkal N. Venkatesan, Portland, OR (US)

(73) Assignee: Intel Corporation, Santa Clara, CA (US)

(21) Appl. No.: 15/621,635

(22) Filed: Jun. 13, 2017

(51) Int. Cl. G06F 9/455; G06F 3/06; G06F 9/445

(52) U.S. Cl. CPC G06F 9/45545; G06F 9/44578; G06F 3/0667; G06F 3/067

(57) ABSTRACT

A computing apparatus, including: a hardware platform; a host operating system on the hardware platform; a virtual machine (VM) having a guest operating system, the VM encapsulated within the host operating system; a plurality of containers encapsulated within the virtual machine; and a virtual switch within a user space of the host operating system, the virtual switch configured to communicatively couple the plurality of containers to one another.

### FIELD OF THE SPECIFICATION

This disclosure relates in general to the field of cloud computing, and more particularly, though not exclusively, to a system and method for container virtual switching.

### BACKGROUND

In some modern data centers, the function of a device or appliance may not be tied to a specific, fixed hardware configuration. Rather, processing, memory, storage, and accelerator functions may in some cases be aggregated from different locations to form a virtual “composite node.” A contemporary network may include a data center hosting a large number of generic hardware server devices, contained in a server rack for example, and controlled by a hypervisor. Each hardware device may run one or more instances of a virtual device, such as a workload server or virtual desktop.

### BRIEF DESCRIPTION OF THE DRAWINGS

The present disclosure is best understood from the following detailed description when read with the accompanying FIGURES. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 is a network-level diagram of a cloud service provider (CSP), according to one or more examples of the present specification.

FIG. 2 is a block diagram of a data center, according to one or more examples of the present specification.

FIG. 3 is a block diagram of a network function virtualization (NFV) architecture, according to one or more examples of the present specification.

FIG. 4 is a block diagram of components of a computing platform, according to one or more examples of the present specification.

FIG. 5 is a block diagram of a hardware platform, according to one or more examples of the present specification.

FIG. 6 illustrates an example wherein network functions are provided in a plurality of virtual machines (VMs), according to one or more examples of the present specification.

FIG. 7 illustrates an example wherein a plurality of containers may be provided on a single hardware platform, according to one or more examples of the present specification.

FIG. 8 is a block diagram of a hardware platform with improved networking, according to one or more examples of the present specification.

FIG. 9 is a flowchart of a method of provisioning a hardware platform for support of container virtual switching, according to one or more examples of the present specification.

FIG. 10 is a block diagram of a resource sled, according to one or more examples of the present specification.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

The massive size of contemporary data centers has made networking within those data centers a premium design consideration. Because of the large volume of traffic within a data center, including the very high volume of so-called “east to west” traffic, packet latency can be a determining factor in the overall efficiency of the data center. As technologies and techniques have improved, data centers have become both more capable and more flexible.

For example, virtualization technology in the data center has largely displaced bespoke network appliances in enterprise networks. An advantage of virtualization is that resources could be dynamically assigned to virtual machines (VMs) on demand, and new instances of a virtual machine could be spun up or spun down as loads on the data center changed.

However, virtual machines have also encountered some difficulties. For example, a contemporary data center may have a demand for a large number of so-called microservices. These microservices may provide a single discrete function, and may be optimized to provide that function very quickly. When very large numbers of microservices or other data center functions are to be provided, the sheer number of virtual machines involved can raise certain practical issues. As a first practical matter, the duplication of the guest operating system per discrete function instance is perceived by some as inefficient. Because each virtual machine requires a discrete amount of processor and memory resources, provisioning of a large number of virtual machines may consume a corresponding large number of physical resources. Another practical concern with the multiplication of virtual machines in the data center is software licensing. Data center operators may pay per-core or per-instance fees for running certain software. Thus, for example, provisioning new instances of an operating system with a per-instance license fee means that each virtual machine incurs that fee.

One response to the challenges associated with VM computing is the use of containers. Unlike virtual appliances, containers run directly in the host operating system on a hardware platform. However, similar to virtual appliances, containers allocate dedicated resources to certain functions to ensure that those functions have sufficient resources to perform their tasks. Thus, containers can realize some of the advantages of virtualization without the need for allocating a separate guest operating system per instance of a function or micro service.

However, moving to containers while altogether abandoning virtualization also abandons decades worth of optimizations, improvements, and toolkits that have been developed around virtualization architectures. For example, software data plane technologies such as the data plane development kit (DPDK) and vector packet processing (VPP) have been successful in accelerating network data planes on general compute platforms. The success of these technologies has contributed to a trend for wireless and wireline network appliances to transition from being hardware defined appliances on application-specific integrated circuits (ASICs) to software defined appliances that are virtualized and deployed as virtual network functions (VNF).

An accompanying trend is toward the decomposition of network appliances into so-called “microservices,” which are very small modular units of execution. The microservices trend is somewhat coupled to the adoption of container and microservices technologies. Because microservices provide benefits in terms of hardware utilization and software licensing, it is advantageous to provide mechanisms to provide technologies to bridge between container and virtualization technologies.

One opportunity for bridging is the use of virtual switches (vSwitches), which provide an important piece of infrastructure in a virtualized network data plane. vSwitches, and particularly those that benefit from highly optimized technologies such as DPDK and VPP, realize very high speed and low latency in providing communication between virtual machines. This can provide a key performance improvement in the data center.

However, container technologies may not be natively compatible with optimized vSwitch technologies. One challenge connected with the implementation of virtual switches in connection with containers is that many containers do not support highly optimized virtual switches, such as switches employing DPDK technology. In some cases, using virtual switches with containers can incur more than two times the number of memory copy operations when compared to a virtual switch in connection with a virtual machine, wherein the virtual machine can be more tightly integrated with the virtual switch.

Some workaround solutions have been proposed for this issue. For example, a shared memory interface may be defined for network appliances embodied within containers, assuming that those network appliances themselves include DPDK support. However, if the network appliances do not include native DPDK support, then this approach may be frustrated.

However, there is no currently defined standard between virtual switches on a shared memory interface. This can lead to support difficulties and validation gaps for network appliance vendors attempting to support more than one virtual switch. Furthermore, there is no existing standard to establish a shared memory interface between the virtual switch and the network appliance, leading to similar challenges.

Another approach is the use of preload libraries for socket-based applications, such as those using Berkeley Software Distribution (BSD) sockets. In this approach, a library may be transparently preloaded by the network appliance, and the library impersonates the kernel's BSD socket application program interface (API). The socket bit stream can then be copied to a network stack running on the virtual switch over a shared memory area.

However, this method also has limitations, as it breaks well-established code paths through the kernel for socket-based applications, and therefore may increase the validation overhead needed for a software vendor to support this solution. Furthermore, in cases where the appliance is provided as an “atomic” application, or in other words an application that may be provided as a prepackaged and essentially indivisible binary, if the image does not already contain support for this solution, then adding support for the solution may involve the need for hacking the binary, and thus violating the integrity of the atomic application.

However, these difficulties can be obviated by providing a hybrid solution that includes support for both the container technology and the virtualization technology. This hybrid solution has the advantage of reaping the benefits of many years of virtualization optimizations, while also providing the advantages of containerization. In this hybrid solution, a hardware platform may be provisioned with a host operating system, and the host operating system launches a single virtual machine having a guest operating system. A large number of containers can then be provisioned within the guest operating system. The virtual machine wrapper around the containers provides access to virtualization optimizations. In particular, the virtual machine can provide support for DPDK and for vSwitch optimizations. To realize the advantages of a high-speed vSwitch, and to reduce the number of unnecessary copy operations, a vSwitch may be provided in the user space of the host operating system rather than in the kernel space, as is traditionally done. Providing the vSwitch in the user space places the vSwitch in the same protection ring as the VM itself, thus enabling the VM and the vSwitch to interoperate directly obviating the need to mediate through additional layers.

This solution substantially realizes the advantages of containerization. Rather than a large number of VMs, each incurring the infrastructure and licensing costs of an individual operating system, a single VM is provided on the hardware platform. This single VM can host a large number of containers, which can provide the actual functionality, including microservices. Thus, embodiments of the present specification provide an architecture wherein the advantages of virtualization, including many years of development of optimized libraries and methods for virtualization, can be combined with the advantages of containerization.

A system and method for container virtual switching will now be described with more particular reference to the attached FIGURES. It should be noted that throughout the FIGURES, certain reference numerals may be repeated to indicate that a particular device or block is wholly or substantially consistent across the FIGURES. This is not, however, intended to imply any particular relationship between the various embodiments disclosed. In certain examples, a genus of elements may be referred to by a particular reference numeral (“widget 10”), while individual species or examples of the genus may be referred to by a hyphenated numeral (“first specific widget 10-1” and “second specific widget 10-2”).

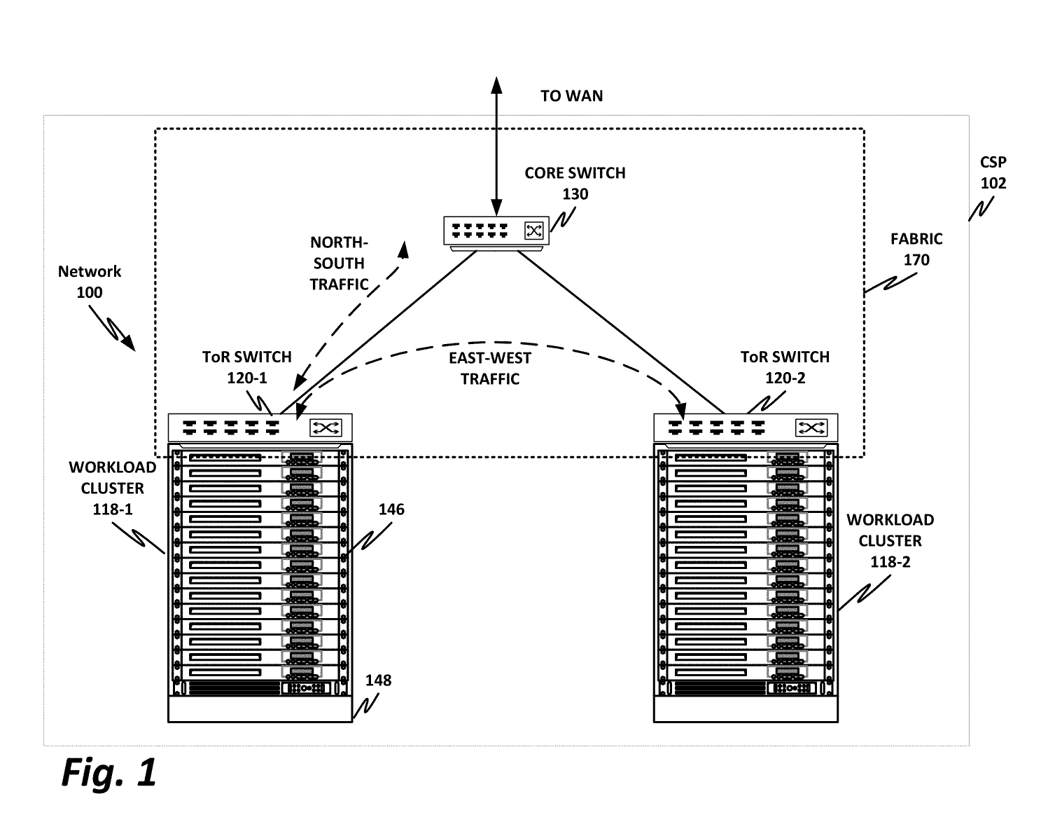

FIG. 1 is a network-level diagram of a network 100 of a cloud service provider (CSP) 102, according to one or more examples of the present specification. CSP 102 may be, by way of nonlimiting example, a traditional enterprise data center, an enterprise “private cloud,” or a “public cloud,” providing services such as infrastructure as a service (IaaS), platform as a service (PaaS), or software as a service (SaaS).

CSP 102 may provision some number of workload clusters 118, which may be clusters of individual servers, blade servers, rackmount servers, or any other suitable server topology. In this illustrative example, two workload clusters, 118-1 and 118-2 are shown, each providing rackmount servers 146 in a chassis 148.

In this illustration, workload clusters 118 are shown as modular workload clusters conforming to the rack unit (“U”) standard, in which a standard rack, 19 inches wide, may be built to accommodate 42 units (42U), each 1.75 inches high and approximately 36 inches deep. In this case, compute resources such as processors, memory, storage, accelerators, and switches may fit into some multiple of rack units from one to 42.

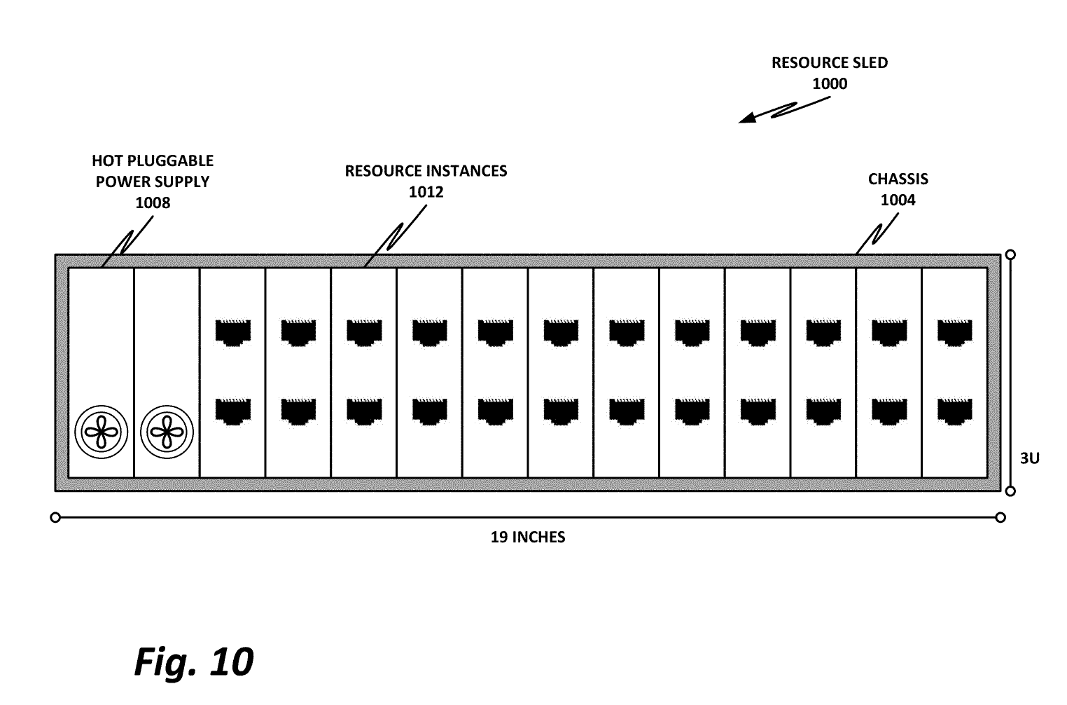

However, other embodiments are also contemplated. For example, FIG. 10 illustrates a resource sled. While the resource sled may be built according to standard rack units (e.g., a 3U resource sled), it is not necessary to do so in a so-called “rackscale” architecture. In that case, entire pre-populated racks of resources may be provided as a unit, with the rack hosting a plurality of compute sleds, which may or may not conform to the rack unit standard (particularly in height). In those cases, the compute sleds may be considered “line replaceable units” (LRUs). If a resource fails, the sled hosting that resource can be pulled, and a new sled can be modularly inserted. The failed sled can then be repaired or discarded, depending on the nature of the failure. Rackscale architecture is particularly useful in the case of software-defined infrastructure (SDI), wherein composite nodes may be built from disaggregated resources. Large resource pools can be provided, and an SDI orchestrator may allocate them to composite nodes as necessary.

Each server 146 may host a standalone operating system and provide a server function, or servers may be virtualized, in which case they may be under the control of a virtual machine manager (VMM), hypervisor, and/or orchestrator, and may host one or more virtual machines, virtual servers, or virtual appliances. These server racks may be collocated in a single data center, or may be located in different geographic data centers. Depending on the contractual agreements, some servers 146 may be specifically dedicated to certain enterprise clients or tenants, while others may be shared.

The various devices in a data center may be connected to each other via a switching fabric 170, which may include one or more high speed routing and/or switching devices. Switching fabric 170 may provide both “north-south” traffic (e.g., traffic to and from the wide area network (WAN), such as the internet), and “east-west” traffic (e.g., traffic across the data center). Historically, north-south traffic accounted for the bulk of network traffic, but as web services become more complex and distributed, the volume of east-west traffic has risen. In many data centers, east-west traffic now accounts for the majority of traffic.

Furthermore, as the capability of each server 146 increases, traffic volume may further increase. For example, each server 146 may provide multiple processor slots, with each slot accommodating a processor having four to eight cores, along with sufficient memory for the cores. Thus, each server may host a number of VMs, each generating its own traffic.

To accommodate the large volume of traffic in a data center, a highly capable switching fabric 170 may be provided. Switching fabric 170 is illustrated in this example as a “flat” network, wherein each server 146 may have a direct connection to a top-of-rack (ToR) switch 120 (e.g., a “star” configuration), and each ToR switch 120 may couple to a core switch 130. This two-tier flat network architecture is shown only as an illustrative example. In other examples, other architectures may be used, such as three-tier star or leaf-spine (also called “fat tree” topologies) based on the “Clos” architecture, hub-and-spoke topologies, mesh topologies, ring topologies, or 3-D mesh topologies, by way of nonlimiting example.

The fabric itself may be provided by any suitable interconnect. For example, each server 146 may include an Intel® Host Fabric Interface (HFI), a network interface card (NIC), or other host interface. The host interface itself may couple to one or more processors via an interconnect or bus, such as PCI, PCIe, or similar, and in some cases, this interconnect bus may be considered to be part of fabric 170.

The interconnect technology may be provided by a single interconnect or a hybrid interconnect, such as where PCIe provides on-chip communication, 1 Gb or 10 Gb copper Ethernet provides relatively short connections to a ToR switch 120, and optical cabling provides relatively longer connections to core switch 130. Interconnect technologies include, by way of nonlimiting example, Intel® Omni-Path™, TrueScale™, Ultra Path Interconnect (UPI) (formerly called QPI or KTI), FibreChannel, Ethernet, FibreChannel over Ethernet (FCoE), InfiniBand, PCI, PCIe, or fiber optics, to name just a few. Some of these will be more suitable for certain deployments or functions than others, and selecting an appropriate fabric for the instant application is an exercise of ordinary skill.

Note however that while high-end fabrics such as Omni-Path™ are provided herein by way of illustration, more generally, fabric 170 may be any suitable interconnect or bus for the particular application. This could, in some cases, include legacy interconnects like local area networks (LANs), token ring networks, synchronous optical networks (SONET), asynchronous transfer mode (ATM) networks, wireless networks such as WiFi and Bluetooth, “plain old telephone system” (POTS) interconnects, or similar. It is also expressly anticipated that in the future, new network technologies will arise to supplement or replace some of those listed here, and any such future network topologies and technologies can be or form a part of fabric 170.

In certain embodiments, fabric 170 may provide communication services on various “layers,” as originally outlined in the OSI seven-layer network model. In contemporary practice, the OSI model is not followed strictly. In general terms, layers 1 and 2 are often called the “Ethernet” layer (though in large data centers, Ethernet has often been supplanted by newer technologies). Layers 3 and 4 are often referred to as the transmission control protocol/internet protocol (TCP/IP) layer (which may be further subdivided into TCP and IP layers). Layers 5-7 may be referred to as the “application layer.” These layer definitions are disclosed as a useful framework, but are intended to be nonlimiting.

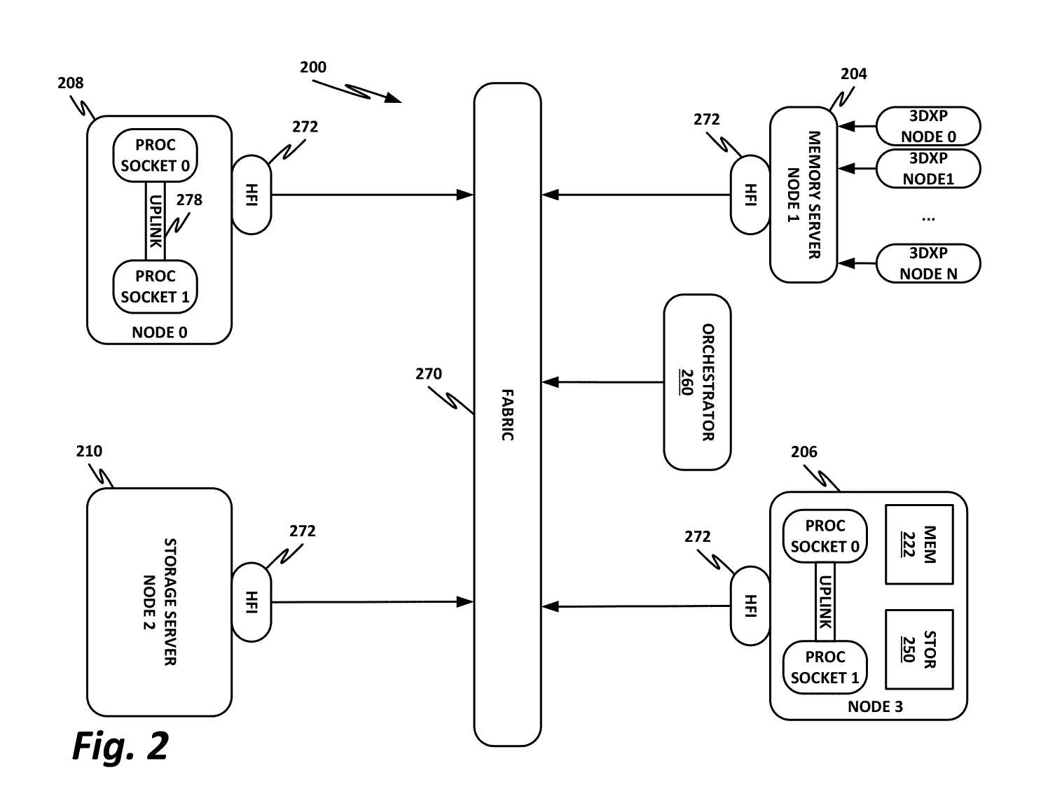

FIG. 2 is a block diagram of a data center 200 according to one or more examples of the present specification. Data center 200 may be, in various embodiments, the same as network 100 of FIG. 1, or may be a different data center. Additional views are provided in FIG. 2 to illustrate different aspects of data center 200.

In this example, a fabric 270 is provided to interconnect various aspects of data center 200. Fabric 270 may be the same as fabric 170 of FIG. 1, or may be a different fabric. As above, fabric 270 may be provided by any suitable interconnect technology. In this example, Intel® Omni-Path™ is used as an illustrative and nonlimiting example.

As illustrated, data center 200 includes a number of logic elements forming a plurality of nodes. It should be understood that each node may be provided by a physical server, a group of servers, or other hardware. Each server may be running one or more virtual machines as appropriate to its application.

Node 0 208 is a processing node including a processor socket 0 and processor socket 1. The processors may be, for example, Intel® Xeon™ processors with a plurality of cores, such as 4 or 8 cores. Node 0 208 may be configured to provide network or workload functions, such as by hosting a plurality of virtual machines or virtual appliances.

Onboard communication between processor socket 0 and processor socket 1 may be provided by an onboard uplink 278. This may provide a very high speed, short-length interconnect between the two processor sockets, so that virtual machines running on node 0 208 can communicate with one another at very high speeds. To facilitate this communication, a virtual switch (vSwitch) may be provisioned on node 0 208, which may be considered to be part of fabric 270.

Node 0 208 connects to fabric 270 via an HFI 272. HFI 272 may connect to an Intel® Omni-Path™ fabric. In some examples, communication with fabric 270 may be tunneled, such as by providing UPI tunneling over Omni-Path™.

Because data center 200 may provide many functions in a distributed fashion that in previous generations were provided onboard, a highly capable HFI 272 may be provided. HFI 272 may operate at speeds of multiple gigabits per second, and in some cases may be tightly coupled with node 0 208. For example, in some embodiments, the logic for HFI 272 is integrated directly with the processors on a system-on-a-chip. This provides very high speed communication between HFI 272 and the processor sockets, without the need for intermediary bus devices, which may introduce additional latency into the fabric. However, this is not to imply that embodiments where HFI 272 is provided over a traditional bus are to be excluded. Rather, it is expressly anticipated that in some examples, HFI 272 may be provided on a bus, such as a PCIe bus, which is a serialized version of PCI that provides higher speeds than traditional PCI. Throughout data center 200, various nodes may provide different types of HFIs 272, such as onboard HFIs and plug-in HFIs. It should also be noted that certain blocks in a system on a chip may be provided as intellectual property (IP) blocks that can be “dropped” into an integrated circuit as a modular unit. Thus, HFI 272 may in some cases be derived from such an IP block.

Note that in “the network is the device” fashion, node 0 208 may provide limited or no onboard memory or storage. Rather, node 0 208 may rely primarily on distributed services, such as a memory server and a networked storage server. Onboard, node 0 208 may provide only sufficient memory and storage to bootstrap the device and get it communicating with fabric 270. This kind of distributed architecture is possible because of the very high speeds of contemporary data centers, and may be advantageous because there is no need to over-provision resources for each node. Rather, a large pool of high-speed or specialized memory may be dynamically provisioned between a number of nodes, so that each node has access to a large pool of resources, but those resources do not sit idle when that particular node does not need them.

In this example, a node 1 memory server 204 and a node 2 storage server 210 provide the operational memory and storage capabilities of node 0 208. For example, memory server node 1 204 may provide remote direct memory access (RDMA), whereby node 0 208 may access memory resources on node 1 204 via fabric 270 in a DMA fashion, similar to how it would access its own onboard memory. The memory provided by memory server 204 may be traditional memory, such as double data rate type 3 (DDR3) dynamic random access memory (DRAM), which is volatile, or may be a more exotic type of memory, such as a persistent fast memory (PFM) like Intel® 3D Crosspoint™ (3DXP), which operates at DRAM-like speeds, but is nonvolatile.

Similarly, rather than providing an onboard hard disk for node 0 208, a storage server node 2 210 may be provided. Storage server 210 may provide a networked bunch of disks (NBOD), PFM, redundant array of independent disks (RAID), redundant array of independent nodes (RAIN), network attached storage (NAS), optical storage, tape drives, or other nonvolatile memory solutions.

Thus, in performing its designated function, node 0 208 may access memory from memory server 204 and store results on storage provided by storage server 210. Each of these devices couples to fabric 270 via a HFI 272, which provides fast communication that makes these technologies possible.

By way of further illustration, node 3 206 is also depicted. Node 3 206 also includes a HFI 272, along with two processor sockets internally connected by an uplink. However, unlike node 0 208, node 3 206 includes its own onboard memory 222 and storage 250. Thus, node 3 206 may be configured to perform its functions primarily onboard, and may not be required to rely upon memory server 204 and storage server 210. However, in appropriate circumstances, node 3 206 may supplement its own onboard memory 222 and storage 250 with distributed resources similar to node 0 208.

The basic building block of the various components disclosed herein may be referred to as “logic elements.” Logic elements may include hardware (including, for example, a software-programmable processor, an ASIC, or an FPGA), external hardware (digital, analog, or mixed-signal), software, reciprocating software, services, drivers, interfaces, components, modules, algorithms, sensors, components, firmware, microcode, programmable logic, or objects that can coordinate to achieve a logical operation. Furthermore, some logic elements are provided by a tangible, non-transitory computer-readable medium having stored thereon executable instructions for instructing a processor to perform a certain task. Such a non-transitory medium could include, for example, a hard disk, solid state memory or disk, read-only memory (ROM), persistent fast memory (PFM) (e.g., Intel® 3D Crosspoint™), external storage, redundant array of independent disks (RAID), redundant array of independent nodes (RAIN), network-attached storage (NAS), optical storage, tape drive, backup system, cloud storage, or any combination of the foregoing by way of nonlimiting example. Such a medium could also include instructions programmed into an FPGA, or encoded in hardware on an ASIC or processor.

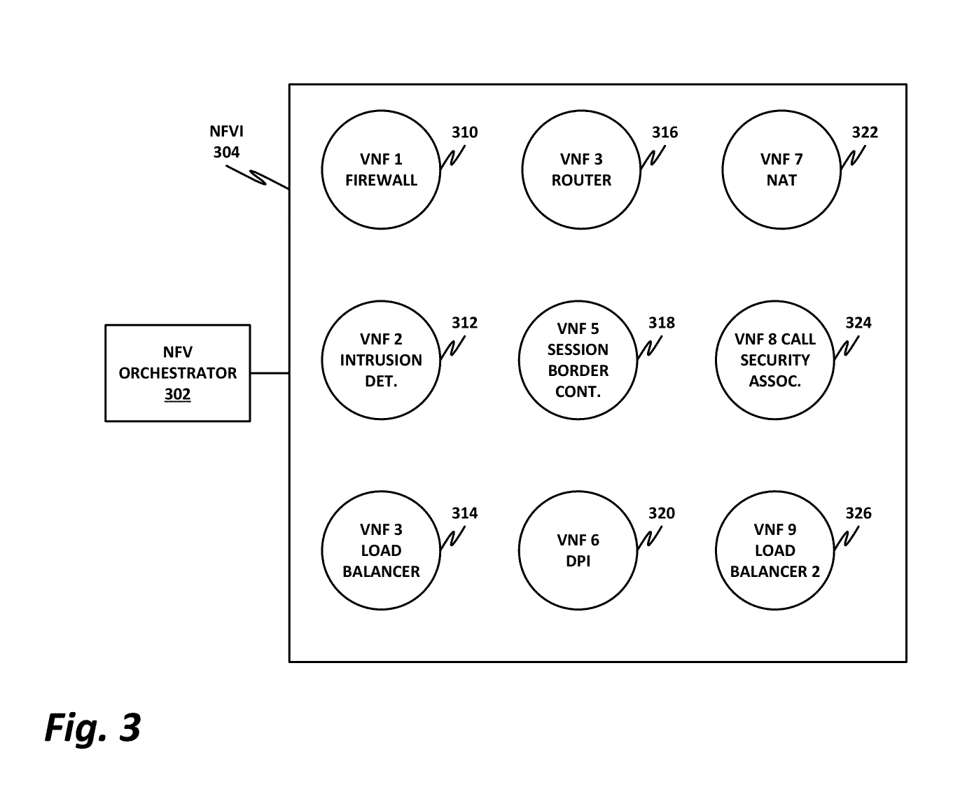

FIG. 3 is a block diagram of a network function virtualization (NFV) architecture according to one or more examples of the present specification. NFV is a second nonlimiting flavor of network virtualization, often treated as an add-on or improvement to SDN, but sometimes treated as a separate entity. NFV was originally envisioned as a method for providing reduced capital expenditure (Capex) and operating expenses (Opex) for telecommunication services. One important feature of NFV is replacing proprietary, special-purpose hardware appliances with virtual appliances running on commercial off-the-shelf (COTS) hardware within a virtualized environment. In addition to Capex and Opex savings, NFV provides a more agile and adaptable network. As network loads change, virtual network functions (VNFs) can be provisioned (“spun up”) or removed (“spun down”) to meet network demands. For example, in times of high load, more load balancer VNFs may be spun up to distribute traffic to more workload servers (which may themselves be virtual machines). In times when more suspicious traffic is experienced, additional firewalls or deep packet inspection (DPI) appliances may be needed.

Because NFV started out as a telecommunications feature, many NFV instances are focused on telecommunications. However, NFV is not limited to telecommunication services. In a broad sense, NFV includes one or more VNFs running within a network function virtualization infrastructure (NFVI). Often, the VNFs are inline service functions that are separate from workload servers or other nodes. These VNFs can be chained together into a service chain, which may be defined by a virtual subnetwork, and which may include a serial string of network services that provide behind-the-scenes work, such as security, logging, billing, and similar.

The illustration of this in FIG. 3 may be considered more functional, compared to more high-level, logical network layouts. Like SDN, NFV is a subset of network virtualization. In other words, certain portions of the network may rely on SDN, while other portions (or the same portions) may rely on NFV.

In the example of FIG. 3, an NFV orchestrator 302 manages a number of the VNFs running on an NFVI 304. NFV requires nontrivial resource management, such as allocating a very large pool of compute resources among appropriate numbers of instances of each VNF, managing connections between VNFs, determining how many instances of each VNF to allocate, and managing memory, storage, and network connections. This may require complex software management, thus the need for NFV orchestrator 302.

Note that NFV orchestrator 302 itself is usually virtualized (rather than a special-purpose hardware appliance). NFV orchestrator 302 may be integrated within an existing SDN system, wherein an operations support system (OSS) manages the SDN. This may interact with cloud resource management systems (e.g., OpenStack) to provide NFV orchestration. An NFVI 304 may include the hardware, software, and other infrastructure to enable VNFs to run. This may include a rack or several racks of blade or slot servers (including, e.g., processors, memory, and storage), one or more data centers, other hardware resources distributed across one or more geographic locations, hardware switches, or network interfaces. An NFVI 304 may also include the software architecture that enables hypervisors to run and be managed by NFV orchestrator 302. Running on NFVI 304 are a number of virtual machines, each of which in this example is a VNF providing a virtual service appliance. These include, as nonlimiting and illustrative examples, VNF 1 310, which is a firewall, VNF 2 312, which is an intrusion detection system, VNF 3 314, which is a load balancer, VNF 4 316, which is a router, VNF 5 318, which is a session border controller, VNF 6 320, which is a deep packet inspection (DPI) service, VNF 7 322, which is a network address translation (NAT) module, VNF 8 324, which provides call security association, and VNF 9326, which is a second load balancer spun up to meet increased demand.

Firewall 310 is a security appliance that monitors and controls the traffic (both incoming and outgoing), based on matching traffic to a list of “firewall rules.” Firewall 310 may be a barrier between a relatively trusted (e.g., internal) network, and a relatively untrusted network (e.g., the Internet). Once traffic has passed inspection by firewall 310, it may be forwarded to other parts of the network.

Intrusion detection 312 monitors the network for malicious activity or policy violations. Incidents may be reported to a security administrator, or collected and analyzed by a security information and event management (SIEM) system. In some cases, intrusion detection 312 may also include antivirus or antimalware scanners.

Load balancers 314 and 326 may farm traffic out to a group of substantially identical workload servers to distribute the work in a fair fashion. In one example, a load balancer provisions a number of traffic “buckets,” and assigns each bucket to a workload server. Incoming traffic is assigned to a bucket based on a factor, such as a hash of the source IP address. Because the hashes are assumed to be fairly evenly distributed, each workload server receives a reasonable amount of traffic.

Router 316 forwards packets between networks or subnetworks. For example, router 316 may include one or more ingress interfaces, and a plurality of egress interfaces, with each egress interface being associated with a resource, subnetwork, virtual private network, or other division. When traffic comes in on an ingress interface, router 316 determines what destination it should go to, and routes the packet to the appropriate egress interface.

Session border controller 318 controls voice over IP (VoIP) signaling, as well as the media streams to set up, conduct, and terminate calls. In this context, “session” refers to a communication event (e.g., a “call”). “Border” refers to a demarcation between two different parts of a network (similar to a firewall).

DPI appliance 320 provides deep packet inspection, including examining not only the header, but also the content of a packet to search for potentially unwanted content (PUC), such as protocol non-compliance, malware, viruses, spam, or intrusions.

NAT module 322 provides network address translation services to remap one IP address space into another (e.g., mapping addresses within a private subnetwork onto the larger internet).

Call security association 324 creates a security association for a call or other session (see session border controller 318 above). Maintaining this security association may be critical, as the call may be dropped if the security association is broken.

The illustration of FIG. 3 shows that a number of VNFs have been provisioned and exist within NFVI 304. This figure does not necessarily illustrate any relationship between the VNFs and the larger network.

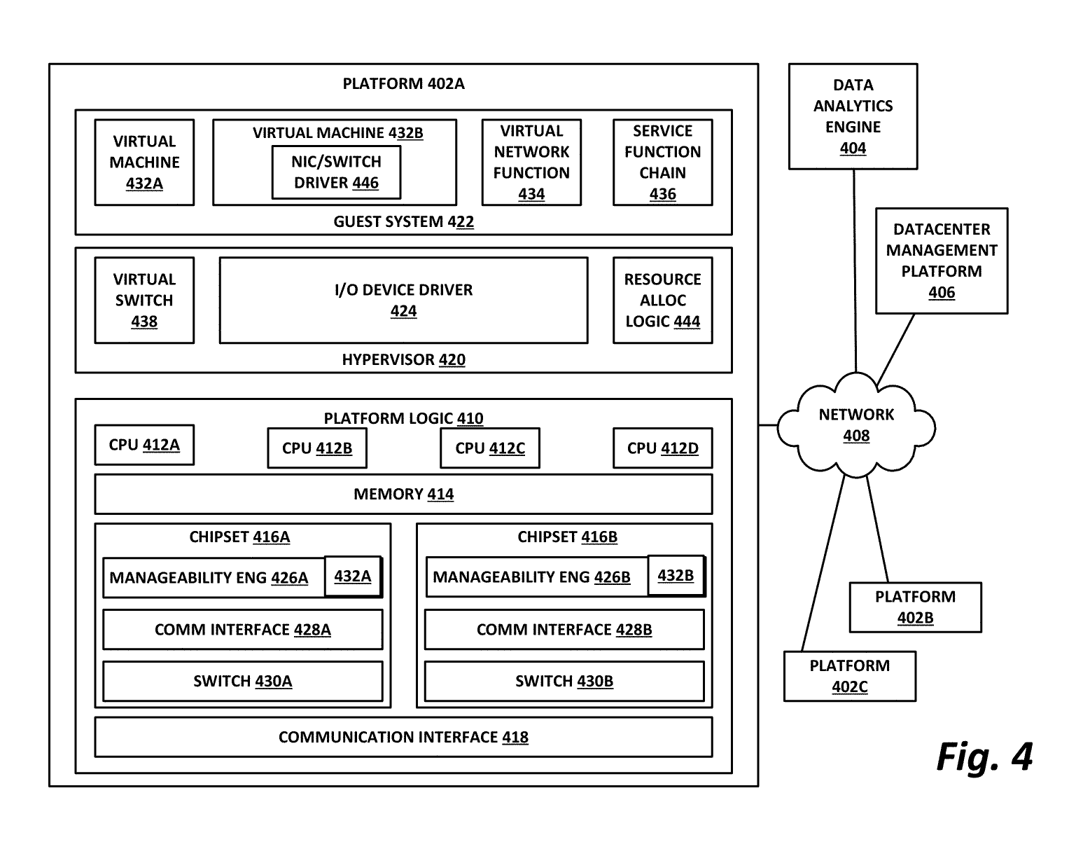

FIG. 4 is a block diagram of components of a computing platform 402A according to one or more examples of the present specification. In the embodiment depicted, platforms 402A, 402B, and 402C, along with a data center management platform 406 and data analytics engine 404 are interconnected via network 408. In other embodiments, a computer system may include any suitable number of (i.e., one or more) platforms. In some embodiments (e.g., when a computer system only includes a single platform), all or a portion of the system management platform 406 may be included on a platform 402. A platform 402 may include platform logic 410 with one or more central processing units (CPUs) 412, memories 414 (which may include any number of different modules), chipsets 416, communication interfaces 418, and any other suitable hardware and/or software to execute a hypervisor 420 or other operating system capable of executing workloads associated with applications running on platform 402. In some embodiments, a platform 402 may function as a host platform for one or more guest systems 422 that invoke these applications. Platform 402A may represent any suitable computing environment, such as a high performance computing environment, a data center, a communications service provider infrastructure (e.g., one or more portions of an Evolved Packet Core), an in-memory computing environment, a computing system of a vehicle (e.g., an automobile or airplane), an Internet of Things environment, an industrial control system, other computing environment, or combination thereof.

In various embodiments of the present disclosure, accumulated stress and/or rates of stress accumulated of a plurality of hardware resources (e.g., cores and uncores) are monitored and entities (e.g., system management platform 406, hypervisor 420, or other operating system) of computer platform 402A may assign hardware resources of platform logic 410 to perform workloads in accordance with the stress information. In some embodiments, self-diagnostic capabilities may be combined with the stress monitoring to more accurately determine the health of the hardware resources. Each platform 402 may include platform logic 410. Platform logic 410 comprises, among other logic enabling the functionality of platform 402, one or more CPUs 412, memory 414, one or more chipsets 416, and communication interfaces 428. Although three platforms are illustrated, computer platform 402A may be interconnected with any suitable number of platforms. In various embodiments, a platform 402 may reside on a circuit board that is installed in a chassis, rack, or other suitable structure that comprises multiple platforms coupled together through network 408 (which may comprise, e.g., a rack or backplane switch).

CPUs 412 may each comprise any suitable number of processor cores and supporting logic (e.g., uncores). The cores may be coupled to each other, to memory 414, to at least one chipset 416, and/or to a communication interface 418, through one or more controllers residing on CPU 412 and/or chipset 416. In particular embodiments, a CPU 412 is embodied within a socket that is permanently or removably coupled to platform 402A. Although four CPUs are shown, a platform 402 may include any suitable number of CPUs.

Memory 414 may comprise any form of volatile or nonvolatile memory including, without limitation, magnetic media (e.g., one or more tape drives), optical media, random access memory (RAM), read-only memory (ROM), flash memory, removable media, or any other suitable local or remote memory component or components. Memory 414 may be used for short, medium, and/or long term storage by platform 402A. Memory 414 may store any suitable data or information utilized by platform logic 410, including software embedded in a computer readable medium, and/or encoded logic incorporated in hardware or otherwise stored (e.g., firmware). Memory 414 may store data that is used by cores of CPUs 412. In some embodiments, memory 414 may also comprise storage for instructions that may be executed by the cores of CPUs 412 or other processing elements (e.g., logic resident on chipsets 416) to provide functionality associated with the manageability engine 426 or other components of platform logic 410. A platform 402 may also include one or more chipsets 416 comprising any suitable logic to support the operation of the CPUs 412. In various embodiments, chipset 416 may reside on the same die or package as a CPU 412 or on one or more different dies or packages. Each chipset may support any suitable number of CPUs 412. A chipset 416 may also include one or more controllers to couple other components of platform logic 410 (e.g., communication interface 418 or memory 414) to one or more CPUs. In the embodiment depicted, each chipset 416 also includes a manageability engine 426. Manageability engine 426 may include any suitable logic to support the operation of chipset 416. In a particular embodiment, a manageability engine 426 (which may also be referred to as an innovation engine) is capable of collecting real-time telemetry data from the chipset 416, the CPU(s) 412 and/or memory 414 managed by the chipset 416, other components of platform logic 410, and/or various connections between components of platform logic 410. In various embodiments, the telemetry data collected includes the stress information described herein.

In various embodiments, a manageability engine 426 operates as an out-of-band asynchronous compute agent which is capable of interfacing with the various elements of platform logic 410 to collect telemetry data with no or minimal disruption to running processes on CPUs 412. For example, manageability engine 426 may comprise a dedicated processing element (e.g., a processor, controller, or other logic) on chipset 416, which provides the functionality of manageability engine 426 (e.g., by executing software instructions), thus conserving processing cycles of CPUs 412 for operations associated with the workloads performed by the platform logic 410. Moreover the dedicated logic for the manageability engine 426 may operate asynchronously with respect to the CPUs 412 and may gather at least some of the telemetry data without increasing the load on the CPUs.

A manageability engine 426 may process telemetry data it collects (specific examples of the processing of stress information will be provided herein). In various embodiments, manageability engine 426 reports the data it collects and/or the results of its processing to other elements in the computer system, such as one or more hypervisors 420 or other operating systems and/or system management software (which may run on any suitable logic such as system management platform 406). In particular embodiments, a critical event such as a core that has accumulated an excessive amount of stress may be reported prior to the normal interval for reporting telemetry data (e.g., a notification may be sent immediately upon detection).

Additionally, manageability engine 426 may include programmable code configurable to set which CPU(s) 412 a particular chipset 416 will manage and/or which telemetry data will be collected.

Chipsets 416 also each include a communication interface 428. Communication interface 428 may be used for the communication of signaling and/or data between chipset 416 and one or more I/O devices, one or more networks 408, and/or one or more devices coupled to network 408 (e.g., system management platform 406). For example, communication interface 428 may be used to send and receive network traffic such as data packets. In a particular embodiment, a communication interface 428 comprises one or more physical network interface controllers (NICs), also known as network interface cards or network adapters. A NIC may include electronic circuitry to communicate using any suitable physical layer and data link layer standard such as Ethernet (e.g., as defined by a IEEE 802.3 standard), Fibre Channel, InfiniBand, Wi-Fi, or other suitable standard. A NIC may include one or more physical ports that may couple to a cable (e.g., an Ethernet cable). A NIC may enable communication between any suitable element of chipset 416 (e.g., manageability engine 426 or switch 430) and another device coupled to network 408. In various embodiments a NIC may be integrated with the chipset (i.e., may be on the same integrated circuit or circuit board as the rest of the chipset logic) or may be on a different integrated circuit or circuit board that is electromechanically coupled to the chipset.

In particular embodiments, communication interfaces 428 may allow communication of data (e.g., between the manageability engine 426 and the data center management platform 406) associated with management and monitoring functions performed by manageability engine 426. In various embodiments, manageability engine 426 may utilize elements (e.g., one or more NICs) of communication interfaces 428 to report the telemetry data (e.g., to system management platform 406) in order to reserve usage of NICs of communication interface 418 for operations associated with workloads performed by platform logic 410.

Switches 430 may couple to various ports (e.g., provided by NICs) of communication interface 428 and may switch data between these ports and various components of chipset 416 (e.g., one or more Peripheral Component Interconnect Express (PCIe) lanes coupled to CPUs 412). Switches 430 may be a physical or virtual (i.e., software) switch.

Platform logic 410 may include an additional communication interface 418. Similar to communication interfaces 428, communication interfaces 418 may be used for the communication of signaling and/or data between platform logic 410 and one or more networks 408 and one or more devices coupled to the network 408. For example, communication interface 418 may be used to send and receive network traffic such as data packets. In a particular embodiment, communication interfaces 418 comprise one or more physical NICs. These NICs may enable communication between any suitable element of platform logic 410 (e.g., CPUs 512 or memory 514) and another device coupled to network 408 (e.g., elements of other platforms or remote computing devices coupled to network 408 through one or more networks).

Platform logic 410 may receive and perform any suitable types of workloads. A workload may include any request to utilize one or more resources of platform logic 410, such as one or more cores or associated logic. For example, a workload may comprise a request to instantiate a software component, such as an I/O device driver 424 or guest system 422; a request to process a network packet received from a virtual machine 432 or device external to platform 402A (such as a network node coupled to network 408); a request to execute a process or thread associated with a guest system 422, an application running on platform 402A, a hypervisor 420 or other operating system running on platform 402A; or other suitable processing request.

A virtual machine 432 may emulate a computer system with its own dedicated hardware. A virtual machine 432 may run a guest operating system on top of the hypervisor 420. The components of platform logic 410 (e.g., CPUs 412, memory 414, chipset 416, and communication interface 418) may be virtualized such that it appears to the guest operating system that the virtual machine 432 has its own dedicated components.

A virtual machine 432 may include a virtualized NIC (vNIC), which is used by the virtual machine as its network interface. A vNIC may be assigned a media access control (MAC) address or other identifier, thus allowing multiple virtual machines 432 to be individually addressable in a network.

VNF 434 may comprise a software implementation of a functional building block with defined interfaces and behavior that can be deployed in a virtualized infrastructure. In particular embodiments, a VNF 434 may include one or more virtual machines 432 that collectively provide specific functionalities (e.g., wide area network (WAN) optimization, virtual private network (VPN) termination, firewall operations, load-balancing operations, security functions, etc.). A VNF 434 running on platform logic 410 may provide the same functionality as traditional network components implemented through dedicated hardware. For example, a VNF 434 may include components to perform any suitable NFV workloads, such as virtualized evolved packet core (vEPC) components, mobility management entities, 3rd Generation Partnership Project (3GPP) control and data plane components, etc.

SFC 436 is a group of VNFs 434 organized as a chain to perform a series of operations, such as network packet processing operations. Service function chaining may provide the ability to define an ordered list of network services (e.g. firewalls, load balancers) that are stitched together in the network to create a service chain.

A hypervisor 420 (also known as a virtual machine monitor) may comprise logic to create and run guest systems 422. The hypervisor 420 may present guest operating systems run by virtual machines with a virtual operating platform (i.e., it appears to the virtual machines that they are running on separate physical nodes when they are actually consolidated onto a single hardware platform) and manage the execution of the guest operating systems by platform logic 410. Services of hypervisor 420 may be provided by virtualizing in software or through hardware assisted resources that require minimal software intervention, or both. Multiple instances of a variety of guest operating systems may be managed by the hypervisor 420. Each platform 402 may have a separate instantiation of a hypervisor 420.

Hypervisor 420 may be a native or bare-metal hypervisor that runs directly on platform logic 410 to control the platform logic and manage the guest operating systems. Alternatively, hypervisor 420 may be a hosted hypervisor that runs on a host operating system and abstracts the guest operating systems from the host operating system. Hypervisor 420 may include a virtual switch 438 that may provide virtual switching and/or routing functions to virtual machines of guest systems 422. The virtual switch 438 may comprise a logical switching fabric that couples the vNICs of the virtual machines 432 to each other, thus creating a virtual network through which virtual machines may communicate with each other.

Virtual switch 438 may comprise a software element that is executed using components of platform logic 410. In various embodiments, hypervisor 420 may be in communication with any suitable entity (e.g., a SDN controller) which may cause hypervisor 420 to reconfigure the parameters of virtual switch 438 in response to changing conditions in platform 402 (e.g., the addition or deletion of virtual machines 432 or identification of optimizations that may be made to enhance performance of the platform).

Hypervisor 420 may also include resource allocation logic 444, which may include logic for determining allocation of platform resources based on the telemetry data (which may include stress information). Resource allocation logic 444 may also include logic for communicating with various components of platform logic 410 entities of platform 402A to implement such optimization, such as components of platform logic 410.

Any suitable logic may make one or more of these optimization decisions. For example, system management platform 406; resource allocation logic 444 of hypervisor 420 or other operating system; or other logic of computer platform 402A may be capable of making such decisions. In various embodiments, the system management platform 406 may receive telemetry data from and manage workload placement across multiple platforms 402. The system management platform 406 may communicate with hypervisors 420 (e.g., in an out-of-band manner) or other operating systems of the various platforms 402 to implement workload placements directed by the system management platform.

The elements of platform logic 410 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g. cache coherent) bus, a layered protocol architecture, a differential bus, or a Gunning transceiver logic (GTL) bus.

Elements of the computer platform 402A may be coupled together in any suitable manner such as through one or more networks 408. A network 408 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices.

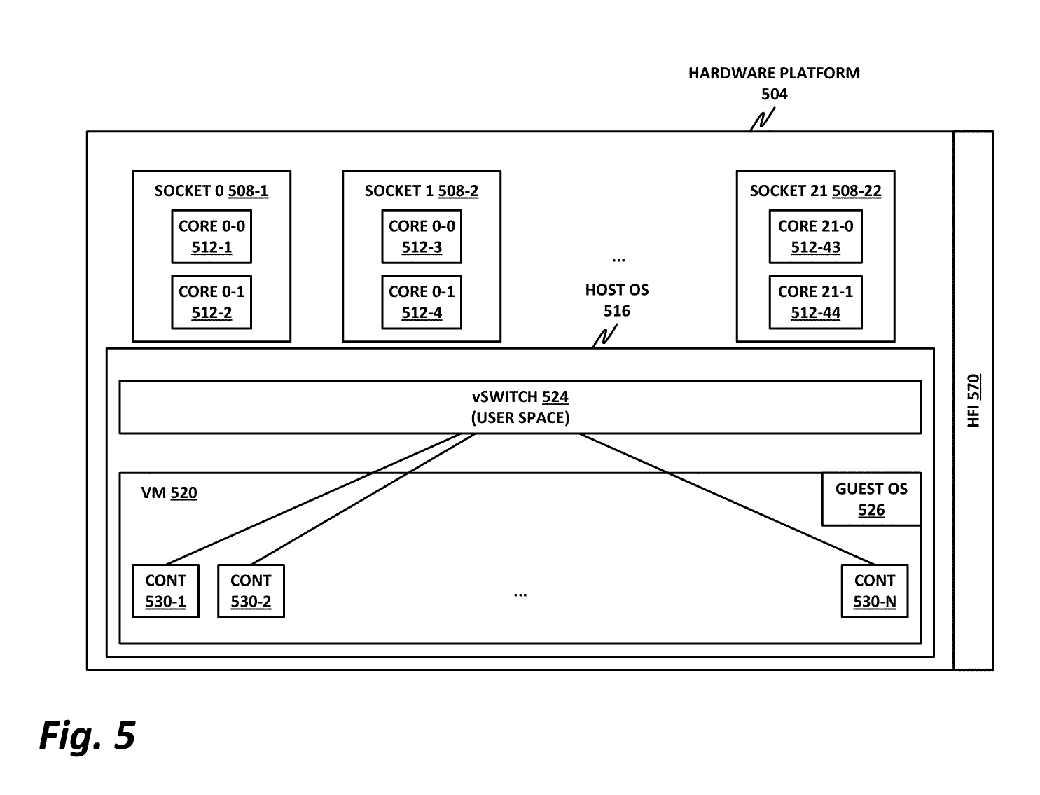

FIG. 5 is a block diagram of a hardware platform 504 according to one or more examples of the present specification. In this case, hardware platform 504 may be, by way of a nonlimiting illustration, a rackmount server in a data center. In this illustration, hardware platform 504 includes a number of sockets, specifically socket 0 508-1, through socket 21 508-22. A two-socket device, with each socket supporting twenty-two cores is a relatively common configuration. Thus, in this embodiment, socket 508 includes two cores 512. For example, socket 0 508-1 includes core 0-0 512-1, and core 0-1 512-2. Socket 21 508-22 includes core 21-0 512-43, and core 21-1 512-44. Thus, in this embodiment, hardware platform 504 includes 44 separate processor cores. Hardware platform 504 interconnects with the rest of the data center via HFI 570.

A host OS 516 runs directly on the hardware of hardware platform 504. There is provisioned within host OS 516 a user space vSwitch 524, and a VM 520. VM 520 includes a guest OS 526, and a plurality of containers 530-1 through 530-N.

In contemporary practice, it is common to host many containers 530 on a single core 512. Indeed, in a 44-core hardware platform as illustrated here, a typical configuration may include two cores allocated to host OS 516, two cores allocated to vSwitch 524, and two cores allocated to guest OS 526 of VM 520. This leaves the remaining 38 cores available for hosting containers. Those 38 cores may commonly host hundreds or thousands of instances of discrete containers. The very high volume of east-west traffic in such a configuration makes the performance of vSwitch 524 an important design consideration in such a system. As illustrated here, the provisioning of containers 530 within VM 520, along with the provisioning of vSwitch 524 in a user space of host OS 516 allows for containers 530 to communicate directly with vSwitch 524, thus reducing the number of copy operations necessary for vSwitch 524 to carry out its switching function.

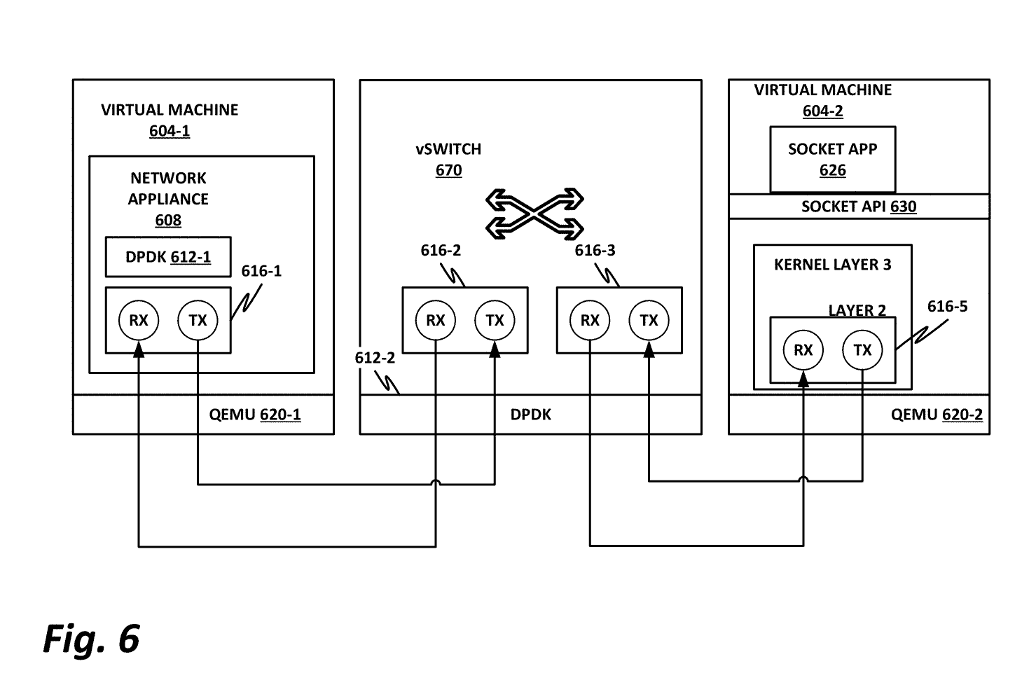

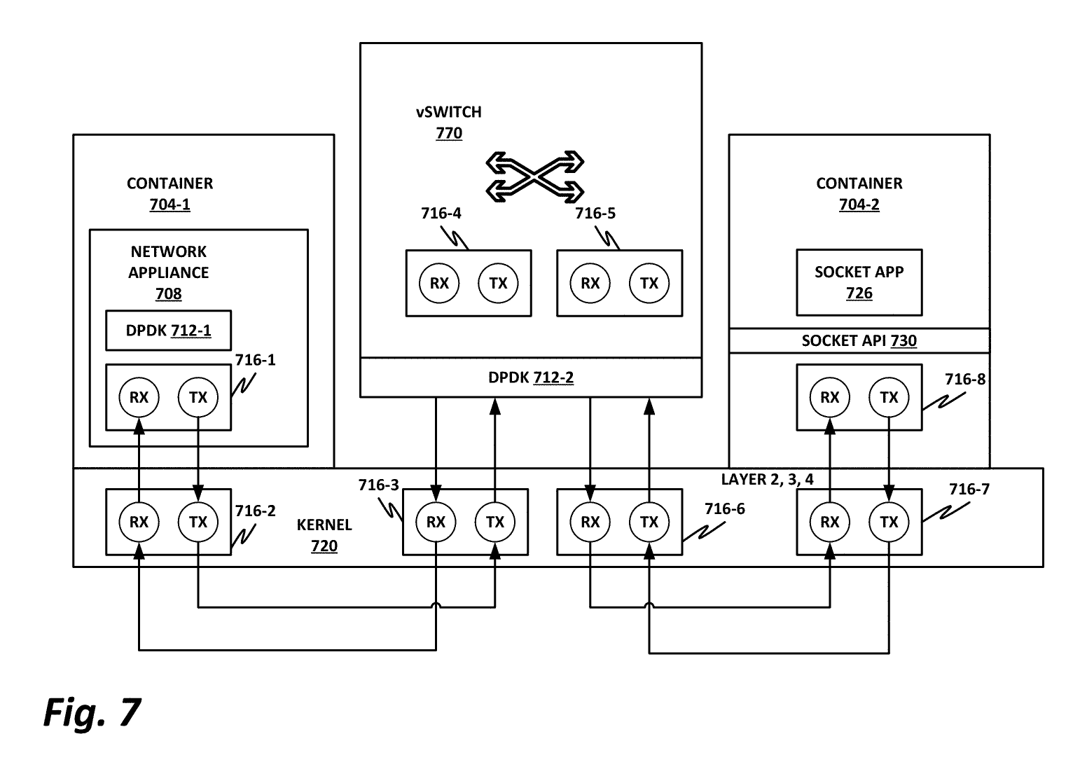

FIGS. 5 and 6 illustrate virtual networking topologies, wherein the performance of a virtualization-based topology leveraging highly optimized DPDK technology may be compared in FIG. 6 to containers operating off of a kernel mode vSwitch in FIG. 7.

FIG. 6 illustrates an embodiment wherein network functions are provided in virtual machine 604-1 and virtual machine 604-2, according to one or more examples of the present specification.

Virtual machine 604-1 hosts a network appliance 608, which includes native support for DPDK 612-1. Virtual machine 604-1 also includes a virtual interface 616-1, with VM 604-1 running on an optimized virtualization platform such as Quick Emulator (QEMU) or a kernel-based virtual machine (KVM).

Virtual machine 604-2 hosts a socket-based application 626. Socket app 626 may not natively support DPDK, but rather may employ BSD-style sockets via a BSD socket API 630. Like virtual machine 604-1, virtual machine 604-2 may run on a technology such as QEMU 620-2, and may provide a virtual interface 616-5. The guest operating system of virtual machine 604-2 provides, below the layer of socket API 630, network layers 2 and 3. Socket API 630 may, by way of example, provide layer 4 of the standard network model.

Virtual machine 604-1 may send east-west traffic to virtual machine 604-2, or may receive east-west traffic from virtual machine 604-2. The two VMs communicatively couple via vSwitch 670, which also includes native DPDK support 612-2. vSwitch 670 includes virtual interfaces 616 for each VM 604, namely virtual interface 616-2 couples to virtual interface 616-1, while virtual interface 616-3 couples to virtual interface 616-5.

As illustrated, during a transmit operation, a data packet is copied from the transmit buffer of virtual interface 616-1 to the transmit buffer of virtual interface 616-2. In this way the packet is copied from the VM 604-1 address space to the vSwitch 670 address space. Once resident in the vSwitch 670 address space the packet may be switched to the receive buffer of virtual interface 616-3, and from there copied to the receive buffer of virtual interface 616-5, and the address space of VM 604-2. Similarly, a transmit from virtual interface 616-5 includes a copy of the packet from the transmit buffer of virtual interface 616-5 to the transmit buffer of virtual interface 616-3, in this way the packet is copied from the address space of VM 604-2 to the address space of the vSwitch 670. The packet is then switched to the receive buffer of virtual interface 616-2, and from there copied to the receive buffer of virtual interface 616-1, and the address space of VM 604-1.

Thus, as illustrated, DPDK is highly optimized to minimize the number of copy operations in east-west traffic, and to ensure that such operations occur quickly. However, challenges may be encountered in the case of containerization.

FIG. 7 illustrates an example wherein a plurality of containers 704 may be provided on a single hardware platform, according to one or more examples of the present specification. Containers 704 may operate in a user space of the host operating system. However, vSwitch 770 may be provided in the kernel space of the host operating system.

As container 704-2's data flows directly to the kernel 720 through the BSD sockets API 730, additional virtual interfaces may need to be defined to accommodate communication between containers 704 and vSwitch 770, mediated through the kernel 720.

Container 704-1 hosts a network appliance 708. Network appliance 708 includes native support for DPDK 712-1. Network appliance 708 also includes virtual interface 716-1.

However, for network appliance 708-1 to communicate with container 704-2 hosting socket app 726, additional interfaces may need to be defined within kernel 720. Thus, within kernel 720, virtual interfaces 716-2 and 716-7 are defined. This enables container 704-1 and container 704-2 to communicate with vSwitch 770 via kernel 720.

For example, if network appliance 708 on container 704-1 needs to communicate with socket app 726 on container 704-2, the transmit may need to traverse virtual interfaces 716-1, 716-2 , so that the data can finally be forwarded to vSwitch 770, having virtual interface 716-4. East-west traffic is then switched between interface 716-4 and 716-5. To move the data from vSwitch 770 to container 704-2, the packet traverses virtual interface 716-5 to virtual interface 716-7 in the kernel space, and finally to virtual interface 716-8 on container 704-2. This multiplicity of containers may be required in some embodiments to maintain the logical separation between the user space and the kernel space.

Thus, while the use of containerization in this embodiment may have realized advantages with respect to infrastructure costs and software licensing costs, these gains have come at the expense of more than doubling the number of copies that occur when a packet is sent from one container 704 to another container 704.

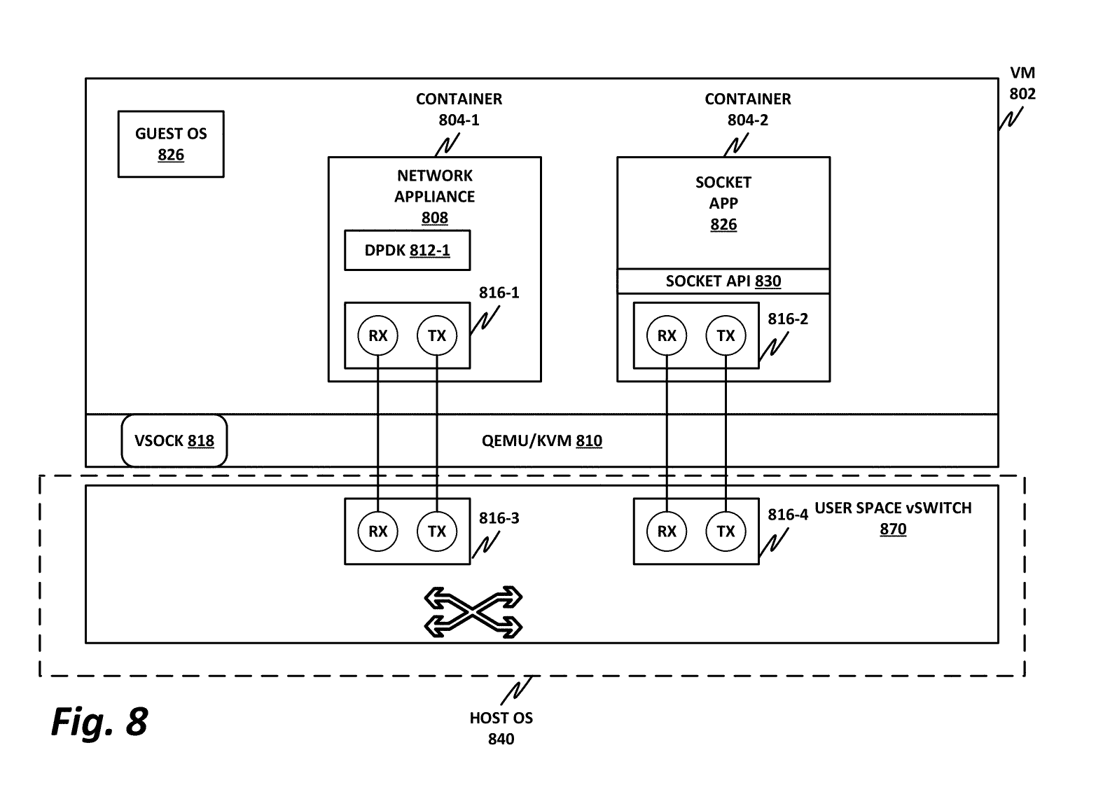

FIG. 8 is a block diagram of a hardware platform with improved networking, according to one or more examples of the present specification. As illustrated in this figure, the number of extraneous copies can be minimized by providing a vSwitch 870 within a user space of host OS 840. This places vSwitch 870 within the same protection ring as VM 802, which also operates within the user space of host OS 840.

VM 802 includes a guest operating system 826. VM 802 runs on top of a technology such QEMU or KVM 810. User space vSwitch 870 includes virtual interfaces 816-3 and 816-4, which couple to virtual interfaces 816-1 and 816-2 on containers 804-1 and 804-2 respectively. Container 804-1 hosts network appliance 808, including native support for DPDK 812-1. Container 804-2 includes socket app 826, which communicates via BSD socket API 830, and lacks native DPDK support.

Advantageously, running containers 804 inside of a VM 802 allows vSwitch 870 to create as many virtual interfaces as may be required, such as one per container 804. The only constraint in this embodiment is the maximum number of virtual interfaces the guest OS 826 PCI bus will support. In current practice, the maximum number of virtual interfaces on the PCI bus is 8,192. Thus, this means that VM 802 may host up to 8,192 containers. This provides adequate room for a single VM to fully utilize its hardware potential on contemporary architectures. Network appliance 808 may use existing and familiar interfaces. For example, network appliance 808 provides native DPDK support, and the virtual interfaces already supported and commonly used.

On the other hand, container 804-2 includes socket app 826, which is based on the BSD socket API 830. Again, virtual interface 816-2 is already supported, such as in the Linux kernel, and is commonly used.

Because containers 804-1 are running on VM 802, the vhost API supported by DPDK enables virtual switch 870 to directly map the guest and container memory into its own address space, thus requiring only one copy from the container to vSwitch 870 in each direction, thus achieving performance parity with native virtualization deployments.

This embodiment may also use the existing vhost API to communicatively couple vSwitch 870 to virtual interfaces 816. Because the vhost API is already well supported by vSwitches, this removes the need to agree to new standards and methods for connecting vSwitches to network appliances.

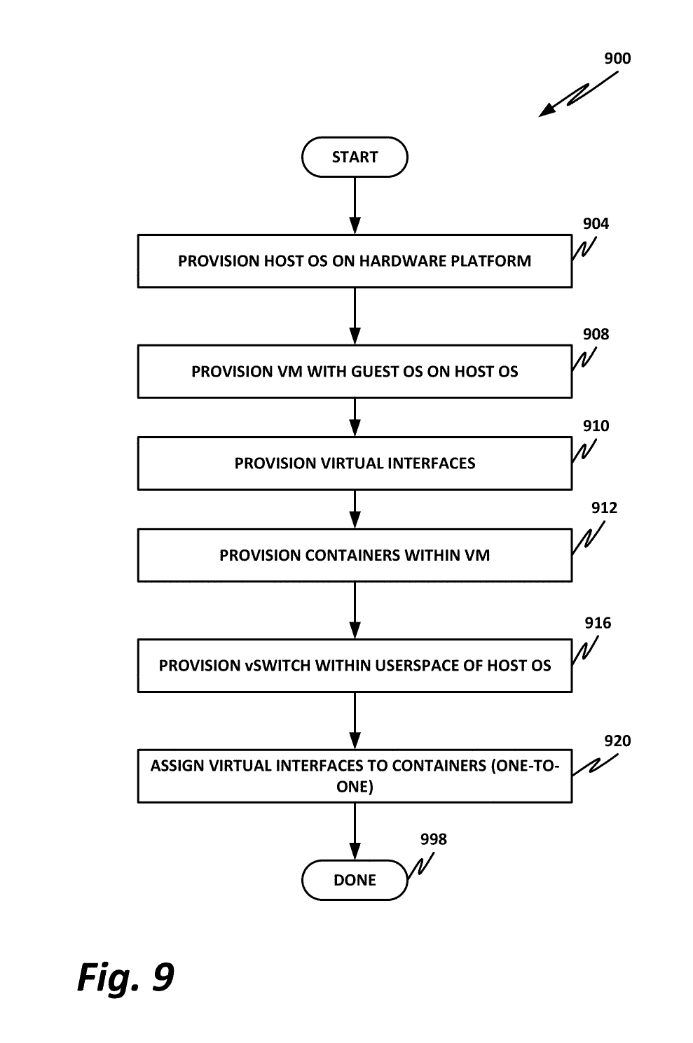

FIG. 9 is a flowchart of a method 900 of provisioning a hardware platform for support of container virtual switching, according to one or more examples of the present specification.

In block 904, a host operating system is provisioned on the hardware platform. The host operating system may include, in some embodiments, a hypervisor so that it has support for launching one or more virtual machines.

In block 908, a virtual machine is provisioned on the host OS, the VM having its own guest OS.

In block 912, one or more virtual interfaces are provisioned for the virtual machine. Note, however, that in some embodiments, virtual interfaces may be hot plugged onto the virtual machine on-demand.

In block 912, a plurality of containers is provisioned within the VM that was provisioned in block 908.

In block 916, a vSwitch is provisioned within the user space of the host OS of the hardware platform. Advantageously, by provisioning the vSwitch within the user space of the host OS, it lies within the same protection ring as the VM itself.

In block 920, virtual interfaces may be assigned to containers, such as in a one-to-one configuration. In other words, each container may have a virtual interface, and within the vSwitch, one additional virtual interface may be configured for each container. Thus, each container may have a direct virtual interface connection to the vhost.

In block 998, the method is done.

FIG. 10 is a block diagram of a resource sled 1000, according to one or more examples of the present specification. In this example, resource sled 1000 includes a chassis 1004. In this example, resource sled 1000 includes a pair of hot pluggable power supplies 1008 which may provide power on the order of a kilowatt each.

Resource sled 1000 also includes a plurality of resource instances 1012. In common practice, resource instances 1012 are substantially identical hardware resources, such as servers providing Intel® Xeon™ processors, high-speed memory, persistent fast memory such as 3D Crosspoint™ memory, solid-state storage media, magnetic storage media, ASICs, or FPGAs by way of nonlimiting example. It should be noted, however, that a sled filled with multiple instances of a common resource is a nonlimiting example only, and it is expressly anticipated herein that a sled may include various dissimilar resources, such as a processor card, a memory card, and a storage card.

Chassis 1004 may provide a common backplane through which resource instances 1012 receive power from power supplies 1008, and through which resource instances 1012 may communicate with one another and with the data center.

Depending on the operational context of the data center, either the individual resource instances 1012 and power supplies 1008 may be considered LRUs, or the entire chassis 1004 may be considered an LRU.

In cases where the individual resource instances are considered an LRU, if one of them fails, then according to its hot-swappable nature, that card may be removed and replaced with an operating and functional card, and operation may resume.

Note that in the particular case where the failure is of the one or more hot pluggable power supplies 1008, replacement of the power supply can enable the rest of resource sled 1000 to resume its operation. Similarly, because the sled may have a single interconnect out to the fabric, the loss of that interconnect (such as by a cable becoming loose or being severed, or a node on a switch going down) may temporarily bring down the whole sled. However, once the connection is restored, the full sled can again immediately begin operation.

The foregoing outlines features of several embodiments so that those skilled in the art may better understand various aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

All or part of any hardware element disclosed herein may readily be provided in a system-on-a-chip (SoC), including central processing unit (CPU) package. An SoC represents an integrated circuit (IC) that integrates components of a computer or other electronic system into a single chip. Thus, for example, client devices or server devices may be provided, in whole or in part, in an SoC. The SoC may contain digital, analog, mixed-signal, and radio frequency functions, all of which may be provided on a single chip substrate. Other embodiments may include a multichip module (MCM), with a plurality of chips located within a single electronic package and configured to interact closely with each other through the electronic package.

Note also that in certain embodiments, some of the components may be omitted or consolidated. In a general sense, the arrangements depicted in the FIGURES may be more logical in their representations, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, and equipment options.

In a general sense, any suitably-configured processor can execute any type of instructions associated with the data to achieve the operations detailed herein. Any processor disclosed herein could transform an element or an article (for example, data) from one state or thing to another state or thing. In operation, a storage may store information in any suitable type of tangible, nontransitory storage medium (for example, random access memory (RAM), read only memory (ROM), field programmable gate array (FPGA), erasable programmable read only memory (EPROM), electrically erasable programmable ROM (EEPROM), etc.), software, hardware (for example, processor instructions or microcode), or in any other suitable component, device, element, or object where appropriate and based on particular needs. Furthermore, the information being tracked, sent, received, or stored in a processor could be provided in any database, register, table, cache, queue, control list, or storage structure, based on particular needs and implementations, all of which could be referenced in any suitable timeframe. Any of the memory or storage elements disclosed herein, should be construed as being encompassed within the broad terms ‘memory’ and ‘storage,’ as appropriate. A nontransitory storage medium herein is expressly intended to include any nontransitory special-purpose or programmable hardware configured to provide the disclosed operations, or to cause a processor to perform the disclosed operations.

Computer program logic implementing all or part of the functionality described herein is embodied in various forms, including, but in no way limited to, a source code form, a computer executable form, machine instructions or microcode, programmable hardware, and various intermediate forms (for example, forms generated by an assembler, compiler, linker, or locator). In an example, source code includes a series of computer program instructions implemented in various programming languages, such as an object code, an assembly language, or a high-level language such as OpenCL, FORTRAN, C, C++, JAVA, or HTML for use with various operating systems or operating environments, or in hardware description languages such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

In one example embodiment, any number of electrical circuits of the FIGURES may be implemented on a board of an associated electronic device. The board can be a general circuit board that can hold various components of the internal electronic system of the electronic device and, further, provide connectors for other peripherals. Any suitable processor and memory can be suitably coupled to the board based on particular configuration needs, processing demands, and computing designs. Note that with the numerous examples provided herein, interaction may be described in terms of two, three, four, or more electrical components. However, this has been done for purposes of clarity and example only. It should be appreciated that the system can be consolidated or reconfigured in any suitable manner. Along similar design alternatives, any of the illustrated components, modules, and elements of the FIGURES may be combined in various possible configurations, all of which are within the broad scope of this specification.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 (pre-AIA) or paragraph (f) of the same section (post-AIA), as it exists on the date of the filing hereof unless the words “means for” or “steps for” are specifically used in the particular claims; and (b) does not intend, by any statement in the specification, to limit this disclosure in any way that is not otherwise expressly reflected in the appended claims.

### EXAMPLE IMPLEMENTATIONS

The following examples are provided by way of illustration.

Example 1 includes a computing apparatus, comprising: a hardware platform; a host operating system on the hardware platform; a virtual machine (VM) having a guest operating system, the VM encapsulated within the host operating system; a plurality of containers encapsulated within the virtual machine; and a virtual switch within a user space of the host operating system, the virtual switch configured to communicatively couple the plurality of containers to one another.

Example 2 includes the computing apparatus of example 1, wherein the plurality of containers includes a container to host an application having support for a data plane development kit (DPDK).

Example 3 includes the computing apparatus of example 1, wherein the plurality of containers includes a container to host a socket-based application.

Example 4 includes the computing apparatus of example 3, wherein the socket-based application lacks support for a data plane development kit (DPDK).

Example 5 includes the computing apparatus of example 3, wherein the socket-based application is an atomic application.

Example 6 includes the computing apparatus of example 5, wherein the atomic application comprises a hash to verify integrity of the atomic application.

Example 7 includes the computing apparatus of any of examples 1-6, wherein the virtual switch includes support for a data plane development kit (DPDK).

Example 8 includes the computing apparatus of any of examples 1-6, wherein address space for the plurality of containers is mapped directly into the virtual switch.

Example 9 includes the computing apparatus of any of examples 1-6, further comprising a proxy to relay a network configuration from the guest operating system to the virtual switch.

Example 10 includes the computing apparatus of any of examples 1-6, wherein the virtual switch comprises one virtual interface per container.

Example 11 includes the computing apparatus of any of examples 1-6, wherein the host operating system comprises a hypervisor.

Example 12 includes the computing apparatus of any of examples 1-6, wherein the hardware platform comprises a composite node having disaggregated hardware resources.

Example 13 includes one or more tangible, non-transitory computer readable mediums having stored thereon executable instructions to: provision a host operating system on a hardware platform; provision a virtual machine (VM) having a guest operating system, the VM encapsulated within the host operating system; provision a plurality of containers encapsulated within the virtual machine; and provision a virtual switch within a user space of the host operating system, the virtual switch configured to communicatively couple the plurality of containers to one another.

Example 14 includes the one or more tangible, non-transitory computer-readable mediums of example 13, wherein the plurality of containers includes a container to host an application having support for a data plane development kit (DPDK).

Example 15 includes the one or more tangible, non-transitory computer-readable mediums of example 13, wherein the plurality of containers includes a container to host a socket-based application.

Example 16 includes the one or more tangible, non-transitory computer-readable mediums of example 15, wherein the socket-based application lacks support for a data plane development kit (DPDK).

Example 17 includes the one or more tangible, non-transitory computer-readable mediums of example 15, wherein the socket-based application is an atomic application.

Example 18 includes the one or more tangible, non-transitory computer-readable mediums of example 17, wherein the atomic application comprises a hash to verify integrity of the atomic application.

Example 19 includes the one or more tangible, non-transitory computer-readable mediums of any of examples 13-18, wherein the virtual switch includes support for a data plane development kit (DPDK).

Example 20 includes the one or more tangible, non-transitory computer-readable mediums of any of examples 13-18, wherein address space for the plurality of containers is mapped directly into the virtual switch.

Example 21 includes the one or more tangible, non-transitory computer-readable mediums of any of examples 13-18, further comprising a proxy to relay a network configuration from the guest operating system to the virtual switch.

Example 22 includes the one or more tangible, non-transitory computer-readable mediums of any of examples 13-18, wherein the virtual switch comprises one virtual interface per container.

Example 23 includes the one or more tangible, non-transitory computer-readable mediums of any of examples 13-18, wherein the host operating system comprises a hypervisor.

Example 24 includes the one or more tangible, non-transitory computer-readable mediums of any of examples 13-18, wherein the hardware platform comprises a composite node having disaggregated hardware resources.

Example 25 includes a computer-implemented method of providing virtual switching for a container, comprising: provisioning a host operating system on a hardware platform; provisioning a virtual machine (VM) having a guest operating system, the VM encapsulated within the host operating system; provisioning a plurality of containers encapsulated within the virtual machine; and provisioning a virtual switch within a user space of the host operating system, the virtual switch configured to communicatively couple the plurality of containers to one another.

Example 26 includes the method of example 25, wherein the plurality of containers includes a container to host an application having support for a data plane development kit (DPDK).

Example 27 includes the method of example 25, wherein the plurality of containers includes a container to host a socket-based application.

Example 28 includes the method of example 27, wherein the socket-based application lacks support for a data plane development kit (DPDK).

Example 29 includes the method of example 27, wherein the socket-based application is an atomic application.

Example 30 includes the method of example 29, wherein the atomic application comprises a hash to verify integrity of the atomic application.

Example 31 includes the method of any of examples 25-30, wherein the virtual switch includes support for a data plane development kit (DPDK).

Example 32 includes the method of any of examples 25-30, wherein address space for the plurality of containers is mapped directly into the virtual switch.

Example 33 includes the method of any of examples 25-30, further comprising a proxy to relay a network configuration from the guest operating system to the virtual switch.

Example 34 includes the method of any of examples 25-30, wherein the virtual switch comprises one virtual interface per container.

Example 35 includes the method of any of examples 25-30, wherein the host operating system comprises a hypervisor.

Example 36 includes the method of any of examples 25-30, wherein the hardware platform comprises a composite node having disaggregated hardware resources.

Example 37 includes an apparatus comprising means for performing the method of any of examples 25-36.

Example 38 includes the apparatus of example 37, wherein the means for performing the method comprise a processor and a memory.

Example 39 includes the apparatus of example 38, wherein the memory comprises machine-readable instructions, that when executed cause the apparatus to perform the method of any of examples 25-36.

Example 40 includes the apparatus of any of examples 37-39, wherein the apparatus is a computing system.

Example 41 includes at least one computer readable medium comprising instructions that, when executed, implement a method or realize an apparatus as illustrated in any of examples 25-40.

What is claimed is:

1. A computing apparatus, comprising:
a hardware platform;
a host operating system on the hardware platform;
a virtual machine (VM) having a guest operating system, the VM encapsulated within the host operating system;
a plurality of containers encapsulated within the virtual machine; and
a virtual switch within a user space of the host operating system, the virtual switch configured to communicatively couple the plurality of containers to one another.

2. The computing apparatus of claim 1, wherein the plurality of containers includes a container to host an application having support for a data plane development kit (DPDK).

3. The computing apparatus of claim 1, wherein the plurality of containers includes a container to host a socket-based application.

4. The computing apparatus of claim 3, wherein the socket-based application lacks support for a data plane development kit (DPDK).

5. The computing apparatus of claim 3, wherein the socket-based application is an atomic application.

6. The computing apparatus of claim 5, wherein the atomic application comprises a hash to verify integrity of the atomic application.

7. The computing apparatus of claim 1, wherein the virtual switch includes support for a data plane development kit (DPDK).

8. The computing apparatus of claim 1, wherein address space for the plurality of containers is mapped directly into the virtual switch.

9. The computing apparatus of claim 1, further comprising a proxy to relay a network configuration from the guest operating system to the virtual switch.

10. The computing apparatus of claim 1, wherein the virtual switch comprises one virtual interface per container.

11. The computing apparatus of claim 1, wherein the host operating system comprises a hypervisor.

12. The computing apparatus of claim 1, wherein the hardware platform comprises a composite node having disaggregated hardware resources.

13. One or more tangible, non-transitory computer readable mediums having stored thereon executable instructions to:
provision a host operating system on a hardware platform;
provision a virtual machine (VM) having a guest operating system, the VM encapsulated within the host operating system;
provision a plurality of containers encapsulated within the virtual machine; and
provision a virtual switch within a user space of the host operating system, the virtual switch configured to communicatively couple the plurality of containers to one another.

14. The one or more tangible, non-transitory computer-readable mediums of claim 13, wherein the plurality of containers includes a container to host an application having support for a data plane development kit (DPDK).

15. The one or more tangible, non-transitory computer-readable mediums of claim 13, wherein the plurality of containers includes a container to host a socket-based application.

16. The one or more tangible, non-transitory computer-readable mediums of claim 15, wherein the socket-based application lacks support for a data plane development kit (DPDK).

17. The one or more tangible, non-transitory computer-readable mediums of claim 15, wherein the socket-based application is an atomic application.

18. The one or more tangible, non-transitory computer-readable mediums of claim 17, wherein the atomic application comprises a hash to verify integrity of the atomic application.

19. The one or more tangible, non-transitory computer-readable mediums of claim 13, wherein the virtual switch includes support for a data plane development kit (DPDK).

20. The one or more tangible, non-transitory computer-readable mediums of claim 13, wherein address space for the plurality of containers is mapped directly into the virtual switch.

21. The one or more tangible, non-transitory computer-readable mediums of claim 13, further comprising a proxy to relay a network configuration from the guest operating system to the virtual switch.

22. The one or more tangible, non-transitory computer-readable mediums of claim 13, wherein the virtual switch comprises one virtual interface per container.

23. The one or more tangible, non-transitory computer-readable mediums of claim 13, wherein the host operating system comprises a hypervisor.

24. The one or more tangible, non-transitory computer-readable mediums of claim 13, wherein the hardware platform comprises a composite node having disaggregated hardware resources.

25. A computer-implemented method of providing virtual switching for a container, comprising:
provisioning a host operating system on a hardware platform;
provisioning a virtual machine (VM) having a guest operating system, the VM encapsulated within the host operating system;
provisioning a plurality of containers encapsulated within the virtual machine; and
provisioning a virtual switch within a user space of the host operating system, the virtual switch configured to communicatively couple the plurality of containers to one another.
